(19) United States
(12) Patent Application Publication
(10) Pub. No.: US 2023/0303831 A1
(43) Pub. Date: Sep. 28, 2023

(54) Biodegradable Living Hinge

(71) Applicant: Meredian, Inc., Bainbridge, GA (US)

(72) Inventors: Ryan Mullins, Tallahassee, FL (US); Russell Mullins, Lagrange, GA (US); Scott Kamann, Bainbridge, GA (US); Adam Johnson, Bainbridge, GA (US)

(73) Assignee: Meredian, Inc., Bainbridge, GA (US)

(21) Appl. No.: 18/191,265

(22) Filed: Mar. 28, 2023

Related U.S. Application Data
(60) Provisional application No. 63/324,396, filed on Mar. 28, 2022.

(51) Int. Cl. C08L 67/04; C08K 5/053; C08K 5/20; A61C 15/04; B65D 1/22; A47G 21/02

(52) U.S. Cl. CPC C08L 67/04; C08K 5/053; C08K 5/20; A61C 15/046; B65D 1/22; A47G 21/02; C08L 2205/025; C08L 2205/24; C08L 2205/06; C08K 2201/014; A47G 2021/002

(57) ABSTRACT

A molded polymer article is disclosed which includes a first structural portion, a second structural portion, and a living hinge connecting the first structural portion and the second structural portion. Both structural portions and the living hinge are all integrally molded from a polymeric composition which includes: (1) from about 20 to about 95 weight percent of polyhydroxyalkanoates, (2) from about 5 to about 75 weight percent of a biodegradable polymer selected from the group consisting of polylactic acid, poly(butylene succinate), poly(butylene-succinate-co-adipate), poly(caprolactone), and poly(butylene adipate-co-terephthalate), (3) from about 0.01 to about 5.0 weight percent of a nucleating agent, and (4) from about 0.01 to about 5.0 weight percent of at least one mold processing aid, such as a mold release agent.

### FIELD

This disclosure relates to biodegradable polymeric compositions. More particularly, this disclosure relates to a molded polymer article which includes a living hinge formed from a biodegradable polymeric composition.

### BACKGROUND

Hinges are ubiquitous in the manufacturing and production of mechanical articles. For injection molded polymer articles, living hinges are commonly used. These living hinges are thin portions of polymer that connect two plastic parts formed from the same polymer. These living hinges must be durable and remain intact with no damage or loss of functionality over the life of the article, which may include hundred or even thousands of cycles of opening and closing the hinge. In order to achieve this desired degree of durability, living hinges have conventionally been formed from polymers such as polypropylene and polyethylene which are not biodegradable or compostable.

With greater concerns for environmental responsibility and sustainability, it would be desirable to provide molded articles with living hinges formed from a biodegradable and/or compostable polymer. However, biodegradable polymers are often quite brittle, causing the living hinge to break after only a few cycles of usage.

Thus, it would be desirable to provide molded polymer articles having a living hinge formed from a biodegradable and/or compostable polymer composition and having improved flexibility and durability to withstand repeated cycles of hinge opening and closing over the life of the molded article.

### SUMMARY OF THE INVENTION

The above and other needs are met by a molded polymer article provided according to the present disclosure. According to one embodiment, this molded polymer article includes a first structural portion, a second structural portion, and a living hinge connecting the first structural portion and the second structural portion.

The first structural portion, the second structural portion, and the living hinge are all integrally molded from a polymeric composition which includes: (1) from about 20 to about 95 weight percent of polyhydroxyalkanoates, (2) from about 5 to about 75 weight percent of a biodegradable polymer selected from the group consisting of polylactic acid, poly(butylene succinate), poly(butylene-succinate-co-adipate), poly(caprolactone), and poly(butylene adipate-co-terephthalate), (3) from about 0.01 to about 5.0 weight percent of a nucleating agent, and (4) from about 0.01 to about 5.0 weight percent of at least one mold processing aid, such as a mold release agent

In certain embodiments, the polymeric composition preferably includes from about 40 to about 95 weight percent of polyhydroxyalkanoates, and from about 5 to about 60 weight percent of a biodegradable polymer selected from the group consisting of polylactic acid, poly(butylene succinate), poly(butylene-succinate-co-adipate), poly(caprolactone) and poly(butylene adipate-co-terephthalate).

In some embodiments, the polymeric composition more preferably includes from about 65 to about 90 weight percent of polyhydroxyalkanoates, and from about 10 to about 35 weight percent of a biodegradable polymer selected from the group consisting of polylactic acid, poly(butylene succinate), poly(butylene-succinate-co-adipate), poly(caprolactone), and poly(butylene adipate-co-terephthalate).

According to certain embodiments, the polymeric composition preferably includes from about 20 to about 95 weight percent of a polyhydroxyalkanoate copolymer. This copolymer is preferably made up of about 75 to about 99 mole percent hydroxybutyrate monomer residues and from about 1 to about 25 mole percent monomer residues of a hydroxyalkanoate selected from the group consisting of hydroxyvalerate, hydroxyhexanoate, hydroxyoctanoate, and hydroxydecanoate.

In some instances, the polymeric composition preferably includes poly-3-hydroxybutyrate-co-3-hydroxyhexanoate (“P(3HB-co-3HHx)”).

In other embodiments, the polymeric composition preferably includes from about 20 to about 95 weight percent of a polyhydroxyalkanoate terpolymer.

In accordance with certain embodiments, the polyhydroxyalkanoates of the polymeric composition have weight average molecular weight from about 50,000 Daltons to about 2.5 million Daltons, as determined by ASTM D5296-05.

In certain embodiments, the polymeric composition preferably includes from about 5 to about 75 weight percent poly(butylene-succinate-co-adipate).

In some embodiments, the polymeric composition preferably includes from about 5 to about 75 weight percent polylactic acid.

In some embodiments, the polymeric composition preferably includes from about 5 to about 75 weight percent poly(caprolactone).

In some instances, the polymeric composition preferably includes from about 5 to about 75 weight percent poly(butylene adipate-co-terephthalate).

In certain embodiments, the polymeric composition is preferably made up less than about 25 weight percent of a filler. More preferably, the polymeric composition is made up of less than about 1 weight percent of a filler. Still more preferably, the polymeric composition is made up of less than about 0.1 weight percent of a filler.

In accordance with certain embodiments the polymeric composition preferably includes from about 0.01 to about 5.0 weight percent of at least one nucleating agent selected from the group consisting of pentaerythritol, boron nitride, polyhydroxybutyrate, and mixtures thereof. More preferably, the polymeric composition includes from about 0.1 to about 2.0 weight percent of at least one nucleating agent selected from the group consisting of pentaerythritol, boron nitride, polyhydroxybutyrate, and mixtures thereof. Still more preferably, the polymeric composition includes from about 0.1 to about 2.0 weight percent of pentaerythritol.

In some embodiments, the polymeric composition preferably includes from about 0.01 to about 5.0 weight percent of at least one mold processing aid which includes an alkyl amide. For instance, the at least one mold processing aid may be selected from the group consisting of behenamide, oleamide, erucamide, stearamide, and mixtures thereof. More preferably, the polymeric composition includes from about 0.1 to about 2.0 weight percent of at least one mold processing aid selected from the group consisting of behenamide, oleamide, erucamide, stearamide, and mixtures thereof.

In certain embodiments, the molded polymer article preferably a flip-top cap. In other embodiments, the molded polymer article is preferably a clamshell container. In still other embodiments, the molded polymer article is preferably a folding cutlery piece. In yet other embodiments, the molded polymer article is preferably a hinged dental flosser.

### DETAILED DESCRIPTION

In a first aspect, the present disclosure provides a molder polymer article which includes at least one living hinge. Preferably, the molded polymer article is biodegradable (as determined by ASTM D5338) and/or compostable (as determined by ASTM D6868). More preferably, the molded polymer article is both biodegradable and compostable.

The polymeric article may be molded into various end use products in accordance with different embodiments of the present disclosure. For instance, in one embodiment, the molded polymer article may be a flip-top cap, such a cap for toothpaste or shampoo. In other embodiments, the molded polymer article may be a clamshell container. In still other embodiments, the molded polymer article may be a folding cutlery piece, such as a fork, knife, spoon, or spork. In yet other embodiments, the molded polymer article is preferably a hinged dental flosser.

In general, the molded polymer article comprises a first structural portion, a second structural portion, and a living hinge connecting the first structural portion and the second structural portion.

For instance, when the molded article is a clamshell container, the first structural portion may be the upper portion of the container and the second structural portion may be lower portion of the container. In embodiments in which the molded article is a folding cutlery piece, the first structural portion may be a handle and the second structural portion may be the eating portion of the cutlery.

In accordance with the present disclosure, the first structural portion, the second structural portion, and the living hinge are all integrally molded from a common polymeric composition. In other words, the first structural portion, the second structural portion, and the living hinge are all molded at the same time and as a single continuous polymeric article. Typically, this is accomplished by injection molding, but other molding methods may also be used.

The polymeric composition from which the article is molded typically comprises at least the following components: (1) polyhydroxyalkanoates, (2) a biodegradable polymer selected from the group consisting of polylactic acid, poly(butylene succinate), poly(butylene-succinate-co-adipate), poly(caprolactone), and poly(butylene adipate-co-terephthalate), (3) a nucleating agent, and (4) at least one mold processing aid.

The amount of the polyhydroxyalkanoates in the polymeric composition is generally from about 20 to about 95 weight percent of the composition. More preferably, the composition comprises from about 40 to about 95 weight percent of polyhydroxyalkanoates. Even more preferably, the composition comprises from about 65 to about 90 weight percent of polyhydroxyalkanoates.

In various embodiments, the polyhydroxyalkanoates may comprise homopolymers, copolymers, and/or terpolymers. In certain embodiments, the polyhydroxyalkanoates more preferably comprise copolymers. For example, in some instances, the polymeric composition preferably comprises poly-3-hydroxybutyrate-co-3-hydroxyhexanoate (“P(3HB-co-3HHx)”).

The polyhydroxyalkanoate copolymer will typically comprise hydroxybutyrate monomer residues as well as monomer residues of a second hydroxyalkanoate. For instance, in some embodiments, the copolymer is preferably made up of about 75 to about 99 mole percent hydroxybutyrate monomer residues and from about 1 to about 25 mole percent monomer residues of a hydroxyalkanoate selected from the group consisting of hydroxyvalerate, hydroxyhexanoate, hydroxyoctanoate, and hydroxydecanoate.

In other embodiments, the polyhydroxyalkanoates more preferably comprise terpolymers.

In some embodiments, these polyhydroxyalkanoates of the polymeric composition preferably have a weight average molecular weight from about 50,000 Daltons to about 2.5 million Daltons, as determined by ASTM D5296-05.

The amount of the biodegradable polymer selected from the group consisting of polylactic acid, poly(butylene succinate), poly(butylene-succinate-co-adipate), poly(caprolactone), and poly(butylene adipate-co-terephthalate), is generally from about 5 to about 75 weight percent of the composition. More preferably, the composition comprises from about 5 to about 60 weight percent of the biodegradable polymer. Even more preferably, the composition comprises from about 10 to about 35 weight percent of the biodegradable polymer.

Thus, in one embodiment, the polymeric composition may comprise from about 5 to about 75 weight percent poly(butylene-succinate-co-adipate), preferably from about 20 to about 60 weight percent, and more preferably from about 25 to about 50 weight percent.

In another embodiment, the polymeric composition may comprise from about 5 to about 75 weight percent polylactic acid, preferably from about 20 to about 60 weight percent, and more preferably from about 25 to about 50 weight percent.

In another embodiment, the polymeric composition may comprise from about 5 to about 75 weight percent poly(caprolactone), preferably from about 20 to about 60 weight percent, and more preferably from about 25 to about 50 weight percent.

In another embodiment, the polymeric composition may comprise from about 5 to about 75 weight percent poly((butylene adipate-co-terephthalate), preferably from about 20 to about 60 weight percent, and more preferably from about 25 to about 50 weight percent.

The polymer composition also comprises a nucleating agent. The amount of the nucleating agent in the polymeric composition is generally from about 0.01 to about 5.0 weight percent of the composition. More preferably, the composition comprises from about 0.1 to about 2.0 weight percent of the nucleating agent.

The nucleating agent is preferably selected from the group consisting of pentaerythritol, boron nitride, polyhydroxybutyrate, and mixtures thereof.

The polymer composition additionally comprises at least one mold processing aid. The amount of the mold processing aid in the polymeric composition is generally from about 0.01 to about 5.0 weight percent of the composition. More preferably, the composition comprises from about 0.1 to about 2.0 weight percent of the mold processing aid. The mold processing aid may for instance be a mold release agent. This mold processing aid is preferably an alkyl amide and may be selected from the group consisting of behenamide, oleamide, eruacmide, steramide, and mixtures thereof.

In some embodiments, the polymer composition may also include one or more plasticizers. Suitable plasticizer may include, for example, epoxidized vegetable oils such as epoxidized soybean oil, epoxidized linseed oil, epoxidized castor oil, epoxidized coconut oil, epoxidized soybean oil, and mixtures thereof; polyethylene glycols, and triglycerides such as triacetin. This plasticizer may be present in the polymer composition in an amount from about 0.1 to about 10 percent by weight, and more preferably from 1 to about 5 percent by weight.

Significantly, in accordance with the present disclosure, the amount of filler in the polymeric composition is minimized. Typically, the polymeric composition comprises less than about 25 weight percent of a filler. More preferably, the polymeric composition comprises less than about 1 weight percent of a filler. Still, more preferably, the polymeric composition comprises less than about 0.1 weight percent of a filler. Suitable examples of fillers which may be used according to the present disclosure include hemp, wood flour, oat hulls, coffee chaff, clays, calcium carbonate, talc, and starch.

As discussed above, the polymeric article may be molded into a variety of end-use products. For instance, the molded polymer article may be a flip-top cap (such as a cap for toothpaste or shampoo), a clamshell container, a folding cutlery piece (such as a fork, knife, spoon, or spork), or a hinged dental flosser.

In these end-use products, the living hinge formed using the polymer composition of the present disclosure has been found to have sufficient durability and flexibility to survive at least 10 cycles of opening and closing without breaking. More preferably, the living hinge can survive at least 100 cycles of opening and closing without breaking.

At the same time, the living hinge, as well as the overall, molded polymer article is preferably biodegradable (as determined by ASTM 5338) and/or compostable (as determined by ASTM D6868). More preferably, the molded polymer article is both biodegradable and compostable.

The present disclosure is also further illustrated by the following embodiments:

Embodiment 1. A molded polymer article comprising:
a first structural portion, a second structural portion, and a living hinge connecting the first structural portion and the second structural portion,
wherein the first structural portion, the second structural portion, and the living hinge are all integrally molded from a polymeric composition comprising:
from about 20 to about 95 weight percent of polyhydroxyalkanoates,
from about 5 to about 75 weight percent of a biodegradable polymer selected from the group consisting of polylactic acid, poly(butylene succinate), poly(butylene-succinate-co-adipate), poly(caprolactone), and poly(butylene adipate-co-terephthalate),
from about 0.01 to about 5.0 weight percent of a nucleating agent, and
from about 0.01 to about 5.0 weight percent of at least one mold processing aid.

Embodiment 2. The molded polymer article of Embodiment 1, wherein the polymeric composition comprises
from about 40 to about 95 weight percent of polyhydroxyalkanoates, and
from about 5 to about 60 weight percent of a biodegradable polymer selected from the group consisting of polylactic acid, poly(butylene succinate), poly(butylene-succinate-co-adipate), poly(caprolactone), and poly(butylene adipate-co-terephthalate),

Embodiment 3. The molded polymer article of Embodiment 1, wherein the polymeric composition comprises
from about 65 to about 90 weight percent of polyhydroxyalkanoates, and
from about 10 to about 35 weight percent of a biodegradable polymer selected from the group consisting of polylactic acid, poly(butylene succinate), poly(butylene-succinate-co-adipate), poly(caprolactone), and poly(butylene adipate-co-terephthalate),

Embodiment 4. The molded polymer article of any of the preceding embodiments, wherein the polymeric composition comprises from about 20 to about 95 weight percent of a polyhydroxyalkanoate copolymer,
wherein the polyhydroxyalkanoate copolymer comprises from about 75 to about 99 mole percent hydroxybutyrate monomer residues and from about 1 to about 25 mole percent monomer residues of a hydroxyalkanoate selected from the group consisting of hydroxyvalerate, hydroxyhexanoate, hydroxyoctanoate, and hydroxydecanoate.

Embodiment 5. The molded polymer article of any of the preceding embodiments, wherein the polymeric composition comprises poly-3-hydroxybutyrate-co-3-hydroxyhexanoate (“P(3HB-co-3HHx)”).

Embodiment 6. The molded polymer article of any of the preceding embodiments, wherein the polyhydroxyalkanoates of the polymeric composition have weight average molecular weight from about 50,000 Daltons to about 2.5 million Daltons, as determined by ASTM D5296-05.

Embodiment 7. The molded polymer article of any of the preceding embodiments, wherein the polymeric composition comprises from about 5 to about 75 weight percent poly(butylene-succinate-co-adipate).

Embodiment 8. The molded polymer article of any of the preceding embodiments, wherein the polymeric composition comprises from about 5 to about 75 weight percent polylactic acid.

Embodiment 9. The molded polymer article of any of the preceding embodiments, wherein the polymeric composition comprises from about 5 to about 75 weight percent poly(caprolactone).

Embodiment 10. The molded polymer article of any of the preceding embodiments, wherein the polymeric composition comprises from about 5 to about 75 weight percent poly(butylene adipate-co-terephthalate).

Embodiment 11. The molded polymer article of any of the preceding embodiments, wherein the polymeric composition comprises less than about 25 weight percent of a filler.

Embodiment 12. The molded polymer article of any of the preceding embodiments, wherein the polymeric composition comprises less than about 1 weight percent of a filler.

Embodiment 13. The molded polymer article of any of the preceding embodiments, wherein the polymeric composition comprises less than about 0.1 weight percent of a filler.

Embodiment 14. The molded polymer article of any of the preceding embodiments, wherein the polymeric composition comprises from about 0.01 to about 5.0 weight percent of at least one nucleating agent selected from the group consisting of pentaerythritol, boron nitride, polyhydroxybutyrate, and mixtures thereof.

Embodiment 15. The molded polymer article of any of the preceding embodiments, wherein the polymeric composition comprises from about 0.1 to about 2.0 weight percent of at least one nucleating agent selected from the group consisting of pentaerythritol, boron nitride, polyhydroxybutyrate, and mixtures thereof.

Embodiment 16. The molded polymer article of any of the preceding embodiments, wherein the polymeric composition comprises from about 0.1 to about 2.0 weight percent of pentaerythritol.

Embodiment 17. The molded polymer article of any of the preceding embodiments, wherein the polymeric composition comprises from about 0.1 to about 10 weight percent of at least one plasticizer selected from the group consisting of epoxidized vegetable oils (such as epoxidized soybean oil, epoxidized linseed oil, epoxidized castor oil, epoxidized coconut oil, epoxidized soybean oil, and mixtures thereof), polyethylene glycols, triglycerides (such as triacetin), and mixtures thereof.

Embodiment 18. The molded polymer article of any of the preceding embodiments, wherein the polymeric composition comprises from about 0.01 to about 5.0 weight percent of at least one mold processing aid selected from the group consisting of behenamide, oleamide, and mixtures thereof.

Embodiment 19. The molded polymer article of any of the preceding embodiments, wherein the polymeric composition comprises from about 0.1 to about 2.0 weight percent of at least one mold processing aid selected from the group consisting of behenamide, oleamide, and mixtures thereof.

Embodiment 20. The molded polymer article of any of the preceding embodiments, wherein the molded polymer article is a flip-top cap.

Embodiment 21. The molded polymer article of any of the preceding embodiments, wherein the molded polymer article is a clamshell container.

Embodiment 22. The molded polymer article of any of the preceding embodiments, wherein the molded polymer article is a folding cutlery piece.

Embodiment 23. The molded polymer article of any of the preceding embodiments, wherein the molded polymer article is a hinged dental flosser.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A molded polymer article comprising:
a first structural portion, a second structural portion, and a living hinge connecting the first structural portion and the second structural portion,
wherein the first structural portion, the second structural portion, and the living hinge are all integrally molded from a polymeric composition comprising:
from about 20 to about 95 weight percent of polyhydroxyalkanoates,
from about 5 to about 75 weight percent of a biodegradable polymer selected from the group consisting of polylactic acid, poly(butylene succinate), poly(butylene-succinate-co-adipate), poly(caprolactone), and poly(butylene adipate-co-terephthalate),
from about 0.01 to about 5.0 weight percent of a nucleating agent, and
from about 0.01 to about 5.0 weight percent of at least one mold processing aid.

2. The molded polymer article of claim 1, wherein the polymeric composition comprises
from about 40 to about 95 weight percent of polyhydroxyalkanoates, and
from about 5 to about 60 weight percent of a biodegradable polymer selected from the group consisting of polylactic acid, poly(butylene succinate), poly(butylene-succinate-co-adipate), poly(caprolactone), and poly(butylene adipate-co-terephthalate),

3. The molded polymer article of claim 1, wherein the polymeric composition comprises
from about 65 to about 90 weight percent of polyhydroxyalkanoates, and
from about 10 to about 35 weight percent of a biodegradable polymer selected from the group consisting of polylactic acid, poly(butylene succinate), poly(butylene-succinate-co-adipate), poly(caprolactone), and poly(butylene adipate-co-terephthalate),

4. The molded polymer article of claim 1, wherein the polymeric composition comprises from about 20 to about 95 weight percent of a polyhydroxyalkanoate copolymer,
wherein the polyhydroxyalkanoate copolymer comprises from about 75 to about 99 mole percent hydroxybutyrate monomer residues and from about 1 to about 25 mole percent monomer residues of a hydroxyalkanoate selected from the group consisting of hydroxyvalerate, hydroxyhexanoate, hydroxyoctanoate, and hydroxydecanoate.

5. The molded polymer article of claim 1, wherein the polymeric composition comprises poly-3-hydroxybutyrate-co-3-hydroxyhexanoate (“P(3HB-co-3HHx)”).

6. The molded polymer article of claim 1, wherein the polymeric composition comprises from about 20 to about 95 weight percent of a polyhydroxyalkanoate terpolymer.

7. The molded polymer article of claim 1, wherein the polyhydroxyalkanoates of the polymeric composition have weight average molecular weight from about 50,000 Daltons to about 2.5 million Daltons, as determined by ASTM D5296-05.

8. The molded polymer article of claim 1, wherein the polymeric composition comprises less than about 25 weight percent of a filler.

9. The molded polymer article of claim 1, wherein the polymeric composition comprises less than about 1 weight percent of a filler.

10. The molded polymer article of claim 1, wherein the polymeric composition comprises from about 0.01 to about 5.0 weight percent of at least one nucleating agent selected from the group consisting of pentaerythritol, boron nitride, polyhydroxybutyrate, and mixtures thereof.

11. The molded polymer article of claim 1, wherein the polymeric composition comprises from about 0.1 to about 2.0 weight percent of at least one nucleating agent selected from the group consisting of pentaerythritol, boron nitride, polyhydroxybutyrate, and mixtures thereof.

12. The molded polymer article of claim 1, wherein the polymeric composition comprises from about 0.1 to about 2.0 weight percent of pentaerythritol.

13. The molded polymer article of claim 1, wherein the polymeric composition comprises from about 0.01 to about 5.0 weight percent of at least one mold processing aid selected from the group consisting of behenamide, oleamide, erucamide, steramide, and mixtures thereof.

14. The molded polymer article of claim 1, wherein the polymeric composition comprises from about 0.1 to about 2.0 weight percent of at least one mold processing aid selected from the group consisting of behenamide, oleamide, erucamide, steramide, and mixtures thereof.

15. The molded polymer article of claim 1, wherein the molded polymer article is a flip-top cap.

16. The molded polymer article of claim 1, wherein the molded polymer article is a clamshell container.

17. The molded polymer article of claim 1, wherein the molded polymer article is a folding cutlery piece.

18. The molded polymer article of claim 1, wherein the molded polymer article is a hinged dental flosser.
